(19) United States
(12) Patent Application Publication
(10) Pub. No.: US 2026/0136476 A1
(43) Pub. Date: May 14, 2026

(54) MOBILE MEMORY DEVICE WITH FINGERPRINT IDENTIFICATION

(71) Applicant: Guangdong Super Industry Group Co., Ltd, Foshan (CN)

(72) Inventors: Zhuowen LIAO, Foshan (CN); Jiewen GUO, Foshan (CN)

(21) Appl. No.: 18/991,287

(22) Filed: Dec. 20, 2024

(30) Foreign Application Priority Data
Nov. 8, 2024 (CN) 202422739065.X

(51) Int. Cl. H05K 5/00; G06V 40/12

(52) U.S. Cl. CPC H05K 5/0086; H05K 5/0017; G06V 40/12

(57) ABSTRACT

A mobile memory device with fingerprint identification includes a shell, a communication socket and a fingerprint identification apparatus; a direction of a pressing force applied on the fingerprint identification apparatus is parallel to a length direction of the communication socket; and therefore, when a user presses the fingerprint identification apparatus for fingerprint identification, the pressing force is parallel to the length direction of the communication socket, the pressing force is identical to an inserting direction of the communication socket, and when the communication socket is inserted into a communication interface, the pressing force is transmitted to a communication device in the inserting direction of the communication socket, and the communication device absorbs the pressing force, so that the communication socket is not deformed or loosened, and the communication socket is prevented from being loosened, deformed and dislocated because the pressing force is perpendicular to the inserting direction.

### TECHNICAL FIELD

The invention relates to the technical field of memory devices, in particular to a mobile memory device with fingerprint identification.

### BACKGROUND OF THE PRESENT INVENTION

With the development of electronic technology, the security and convenience of data transmission are paid more and more attention. Therefore, mobile memory devices are widely used in file data transmission on mobile phones and PCs. As a mobile memory device, a USB flash drive is widely used due to the advantages of small size, high speed, light weight, portability and good compatibility.

With the popularization and multi-aspect application of the U-drive, the security problem also follows, and how to protect information stored on the U-drive has become a problem that both users and manufacturers need to consider. Therefore, in some technologies, a fingerprint identification device is arranged on the U-drive to ensure the security of files in the U-drive through fingerprint identification.

At present, according to the U-drive with fingerprint identification, a fingerprint identification area is located on a side wall surface of the U-drive, and a USB socket is arranged on a front end surface. An inserting direction of the USB socket is parallel to a plane on which the fingerprint identification area is located, a user presses a finger on the fingerprint identification area when unlocking the fingerprint identification area, and a pressing force is perpendicular to the inserting direction of the USB socket, which will lead to the loosening and deformation of a matching place between the USB socket and a USB interface. In a process of fingerprint identification, the connection between the U-drive and a mobile terminal is interrupted; and the U-drive cannot be used normally.

### SUMMARY OF THE PRESENT INVENTION

(I) One of the technical problems to be solved by the present invention is that: an existing mobile memory device with fingerprint identification has the problem of looseness and deformation at a matching place between a socket of the mobile memory device and an interface of mobile memory device.

(II) Technical solution

In order to solve the above technical problem, the present invention provides a mobile memory device with fingerprint identification, wherein an accommodating cavity is formed in a shell, one end of a communication socket is located in the accommodating cavity, and the other end of the communication socket extends out of the accommodating cavity; and one surface of a fingerprint identification apparatus used for acquiring a fingerprint is located on an outer side of the shell, and a direction of a pressing force applied on the fingerprint identification apparatus when the fingerprint identification apparatus acquires the external fingerprint is parallel to a length direction of the communication socket.

According to one embodiment of the present invention, the shell is provided with a first wall and a second wall which are oppositely arranged; and

the fingerprint identification apparatus is mounted on the first wall, one end of the communication socket is located in the accommodating cavity, and the other end of the communication socket penetrates through the second wall to extend out of the accommodating cavity.

According to one embodiment of the present invention, the first wall is parallel to the second wall, the length direction of the communication socket is perpendicular to a plane on which the second wall is located, and the plane on which the fingerprint identification apparatus is located is parallel to a plane on which the first wall is located.

According to one embodiment of the present invention, the first wall of the shell is provided with a first through hole communicated with the accommodating cavity, and the fingerprint identification apparatus is located in the first through hole.

According to one embodiment of the present invention, the second wall is provided with a second through hole, and one end of the communication socket penetrates through the second through hole to extend out of the accommodating cavity.

According to one embodiment of the present invention, an outer wall surface of the second wall is provided with a circle of protrusion corresponding to the second through hole, a first cavity is arranged in the protrusion, one end of the first cavity is communicated with the second through hole, and the other end of the first cavity is communicated with the outside.

According to one embodiment of the present invention, cross-sectional shape and size of the first cavity are matched with cross-sectional shape and size of the second through hole.

According to one embodiment of the present invention, the shell comprises a cover and a lower shell; and

the cover and the lower shell both have a structure with one open end, and the open ends of the cover and the lower shell are detachably connected; and the accommodating cavity is formed between the open end of the cover and the open end of the lower shell which are connected.

According to one embodiment of the present invention, an inner wall of the open end of the lower shell is provided with a circle of ring groove, the open end of the cover is inserted into the lower shell, and the open end of the lower shell abuts against the ring groove.

According to one embodiment of the present invention, an outer wall surface of the second wall is provided with a plurality of parallel grooves arranged at intervals.

The present invention has the following beneficial effects: the mobile memory device with fingerprint identification provided by the present application comprises the shell, the communication socket and the fingerprint identification apparatus; wherein, the direction of the pressing force applied on the fingerprint identification apparatus is parallel to the length direction of the communication socket; and therefore, when a user presses the fingerprint identification apparatus for fingerprint identification, the pressing force is parallel to the length direction of the communication socket, the pressing force is identical to the inserting direction of the communication socket, and when the communication socket is inserted into a communication interface, the pressing force is transmitted to a communication device in the inserting direction of the communication socket, and the communication device absorbs the pressing force, so that the communication socket will not be deformed or loosened, and the communication socket can be prevented from being loosened, deformed and dislocated because the pressing force is perpendicular to the inserting direction, thus avoiding the mobile memory device or the communication device from being damaged.

### DESCRIPTION OF THE DRAWINGS

The above and/or additional aspects and advantages of the present invention will be apparent and easily understood from the descriptions of embodiments with reference to the following drawings, wherein:

FIG. 1 is a stereoscopic diagram of a mobile memory device with fingerprint identification provided by an embodiment of the present invention;

FIG. 2 is a top view of the mobile memory device with fingerprint identification provided by the embodiment of the present invention;

FIG. 3 is a bottom view of the mobile memory device with fingerprint identification provided by the embodiment of the present invention;

FIG. 4 is an exploded view of the mobile memory device with fingerprint identification provided by the embodiment of the present invention;

FIG. 5 is a stereoscopic diagram of a cover provided by the embodiment of the present invention from one perspective;

FIG. 6 is a stereoscopic diagram of the cover provided by the embodiment of the present invention from another perspective; and

FIG. 7 is a stereoscopic diagram of a lower shell provided by the embodiment of the present invention.

### REFERENCE NUMERALS ARE AS FOLLOWS

1 refers to mobile memory device with fingerprint identification; 11 refers to cover; 111 refers to second wall; 1111 refers to second through hole; 1112 refers to groove; 1113 refers to convex strip; 1114 refers to protrusion; and 1115 refers to first cavity;
12 refers to lower shell; 121 refers to first wall; 1211 refers to first through hole; and 1212 refers to sinking platform;
13 refers to communication socket; 14 refers to first PCB board; 15 refers to second PCB board; 16 refers to pin header; 17 refers to fingerprint identification apparatus; and 18 refers to memory.

### DETAILED DESCRIPTION OF PREFERRED EMBODIMENTS

In order to understand the above objectives, features and advantages of present invention more clearly, the present invention is further described in detail hereinafter with reference to the drawings and specific embodiments. It should be noted that, in the case of no conflict, the embodiments of the present application and the features in the embodiments may be combined with each other.

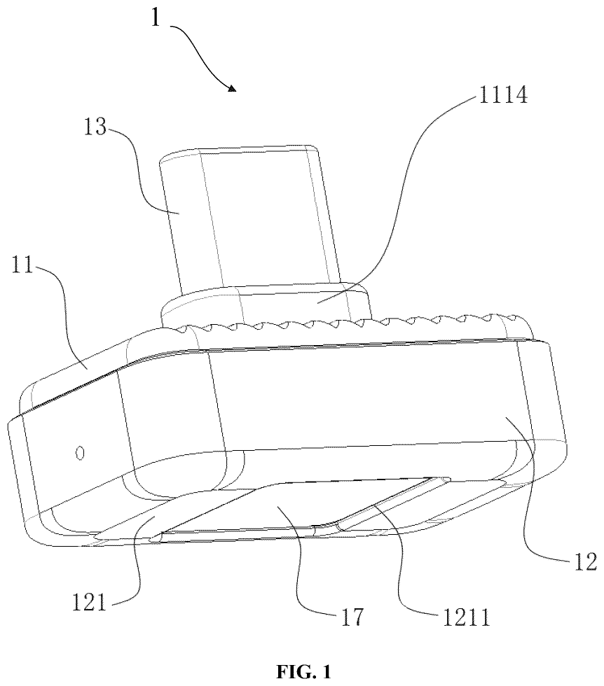

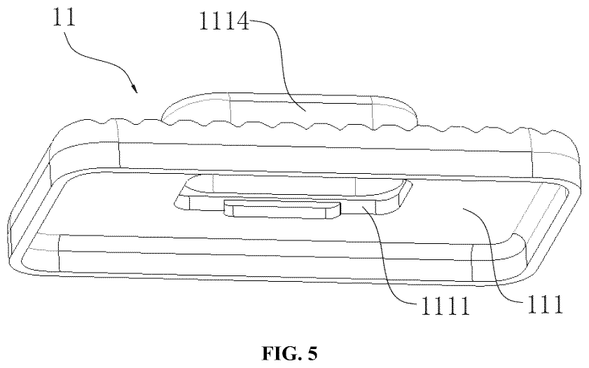

As shown in FIG. 1 to FIG. 7, the present invention provides a mobile memory device 1 with fingerprint identification, which comprises a shell, a fingerprint identification apparatus 17 and a communication socket 13; wherein, an accommodating cavity is formed in the shell, one end of the communication socket 13 is located in the accommodating cavity, and the other end of the communication socket extends out of the accommodating cavity; and one surface of the fingerprint identification apparatus 17 used for acquiring a fingerprint is located on an outer side of the shell, and a direction of a pressing force applied on the fingerprint identification apparatus 17 when the fingerprint identification apparatus 17 acquires the external fingerprint is parallel to a length direction of the communication socket 13.

The mobile memory device 1 with fingerprint identification provided by the present application comprises the shell, the communication socket 13 and the fingerprint identification apparatus 17; wherein, the direction of the pressing force applied on the fingerprint identification apparatus 17 when the fingerprint identification apparatus 17 acquires the external fingerprint is parallel to the length direction of the communication socket 13, and the length direction of the communication socket 13 is a direction of inserting the communication socket 13 into the communication device when the communication socket is connected with the external communication device; and therefore, when a user presses the fingerprint identification apparatus 17 for fingerprint identification, the pressing force is parallel to the length direction of the communication socket 13, the pressing force is identical to the inserting direction of the communication socket 13, and when the communication socket 13 is inserted into a communication interface, the pressing force is transmitted to a communication device in the inserting direction of the communication socket 13, and the communication device absorbs the pressing force, so that the communication socket 13 will not be deformed or loosened, and the communication socket 13 can be prevented from being loosened, deformed and dislocated because the pressing force is perpendicular to the inserting direction of the communication socket 13, thus avoiding the mobile memory device 1 with fingerprint identification or the communication device from being damaged.

The mobile memory device 1 with fingerprint identification in the present application may be a USB flash drive (U-drive), an SD card, a solid-state hard disk SSD, an embedded memory card, or the like; and a matched communication device may be a smart phone, a tablet computer, a PC, and the like. Preferably, in the present application, the mobile memory device 1 with fingerprint identification is the USB flash drive, and the communication device is the smart phone.

According to an existing U-drive with a fingerprint identification function for the smart phone, the fingerprint identification apparatus 17 is located on a side wall of a shell of the U-drive, the communication socket 13 is located at one end in the length direction, and the length direction of the communication socket 13 is the same as a length direction of the U-drive. During fingerprint identification, the direction of the pressing force generated by a finger pressing the fingerprint identification apparatus 17 is perpendicular to the length direction of the communication socket 13, so that the pressing force will be applied to the U-drive. Moreover, the pressing force is perpendicular to the inserting direction of the communication socket 13, and when the communication socket 13 of the U-drive is inserted into the communication interface, there are no stress targets on two sides of the shell of the U-drive in the direction of the pressing force, so that the pressing force applied on the communication socket 13 is easy to lead to the deformation and looseness of the communication socket 13. Moreover, in the present application, because the pressing force generated by pressing the fingerprint identification apparatus 17 is identical to the inserting direction of the communication socket 13, when the communication socket 13 is inserted into the communication interface, the pressing force is transmitted to the communication device in the inserting direction of the communication socket 13, so that the communication socket 13 will not be deformed or loosened.

It should be noted that, in this embodiment, the length direction of the communication socket 13 and the direction of the pressing force applied on the fingerprint identification apparatus 17 may not be absolutely parallel, for example, an included angle between the two directions is an acute angle, as long as most component force of the pressing force applied on the mobile memory device 1 with fingerprint identification by pressing the fingerprint identification apparatus 17 is in the length direction of the communication socket 13, and meanwhile, the pressing force generated by pressing the fingerprint identification apparatus 17 can also be transmitted to the communication device, so as to avoid the communication socket 13 of the mobile memory device 1 with fingerprint identification from being deformed and loosened under the pressing force. This purpose does not deviate from the design idea of the present invention, and should belong to the scope of protection of the present invention.

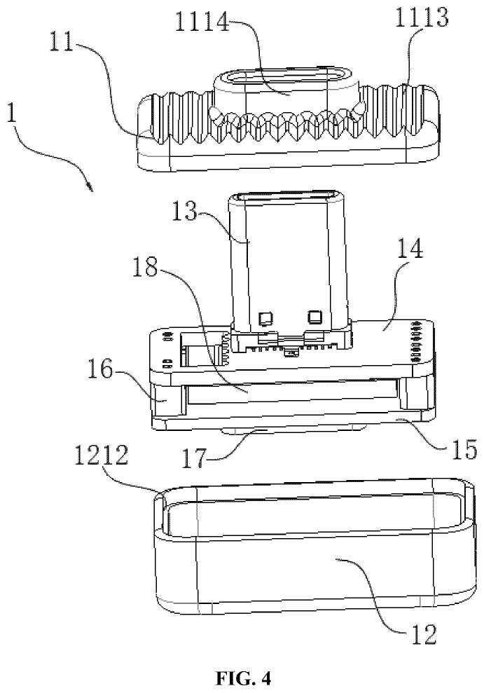

According to one embodiment of the present invention, as shown in FIG. 1 and FIG. 4, the shell is provided with a first wall 121 and a second wall 111 which are oppositely arranged; the fingerprint identification apparatus 17 is mounted on the first wall 121, one end of the communication socket 13 is located in the accommodating cavity, and the other end of the communication socket penetrates through the second wall 111 to extend out of the accommodating cavity; and the length direction of the communication socket 13 is perpendicular to a plane on which the fingerprint identification apparatus 17 is located. In this embodiment, the communication socket 13 and the fingerprint identification apparatus 17 are respectively mounted on two opposite walls of the shell, so that a volume of the shell can be reduced, thus miniaturizing and integrating the mobile memory device 1 with fingerprint identification.

It should be noted that, in this embodiment, the fingerprint identification apparatus 17 and the communication socket 13 may not be arranged on two opposite side walls, for example, the communication socket 13 penetrates through the second wall 111 to extend out of the accommodating cavity, and the fingerprint identification apparatus 17 is arranged on the side wall of the shell perpendicular to the second wall 111, as long as the length direction of the communication socket 13 (the inserting direction of the communication socket 13) is perpendicular to a pressing plane of the fingerprint identification apparatus 17, so that the design idea of the present invention can also be realized by making the pressing force parallel to the inserting direction of the communication socket 13, which should belong to the scope of protection of the present invention.

Preferably, as shown in FIG. 1 and FIG. 4, the first wall 121 is parallel to the second wall 111, the length direction of the communication socket 13 is perpendicular to a plane on which the second wall 111 is located, and the plane on which the fingerprint identification apparatus 17 is located is parallel to a plane on which the first wall 121 is located. As shown in FIG. 1 and FIG. 4, the shell has a rectangular shell structure, and the first wall 121 and the second wall 111 are located at a top portion and a bottom portion of the shell respectively.

As shown in FIG. 4, the mobile memory device 1 with fingerprint identification further comprises a memory 18, a first PCB board 14 and a second PCB board 15, wherein the memory 18, the first PCB board 14 and the second PCB board 15 are all located in the accommodating cavity, and the first PCB board 14 is electrically connected with the second PCB board 15 through a pin header 16. The memory 18 is electrically connected with the first PCB board 14, one end of the communication socket 13 is electrically connected with the first PCB board 14, the other end of the communication socket penetrates through the second wall 111, and the fingerprint identification apparatus 17 is electrically connected with the second PCB board 15. A control unit may be integrated on the first PCB board 14 and/or the second PCB board 15, the control unit is electrically connected with the fingerprint identification apparatus 17 and the communication socket 13 respectively, the control unit may receive a fingerprint signal collected by the fingerprint identification apparatus 17, and the fingerprint signal is compared with a remaining target signal to generate a control instruction to control the memory 18, wherein the memory 18 in the present application may be a FLASH memory. A control logic of a controller to control the memory 18 and the fingerprint identification apparatus 17 is the prior art, which will not be repeated herein.

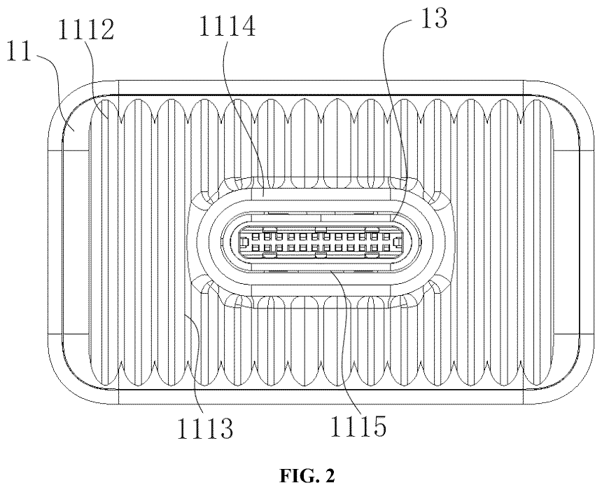

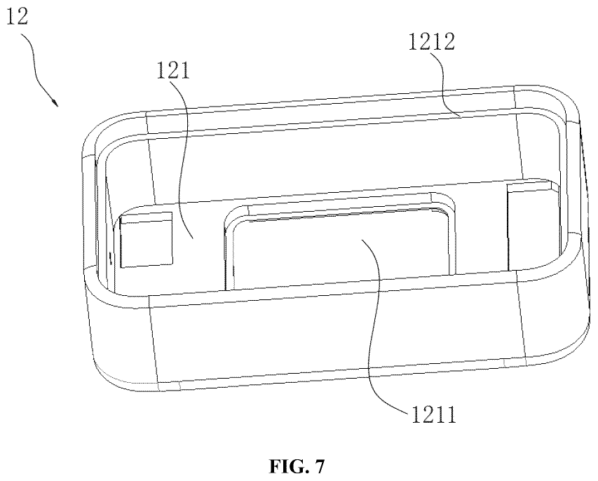

According to one embodiment of the present invention, as shown in FIG. 1, FIG. 2 and FIG. 7, the first wall 121 of the shell is provided with a first through hole 1211 communicated with the accommodating cavity, and the fingerprint identification apparatus 17 is located in the first through hole 1211. The fingerprint identification apparatus 17 comprises a fingerprint input panel, the fingerprint input panel is fixedly connected with the second PCB board 15, and the fingerprint input panel is located in the first through hole 1211. A user may press a finger on the fingerprint input panel for fingerprint identification and input. Preferably, the fingerprint input panel has a flat structure, the fingerprint input panel is parallel to the second wall 111, and an outer wall surface of the fingerprint input panel is lower than an outer wall surface of the second wall 111, that is, the outer wall surface of the fingerprint input panel is located in the first through hole 1211.

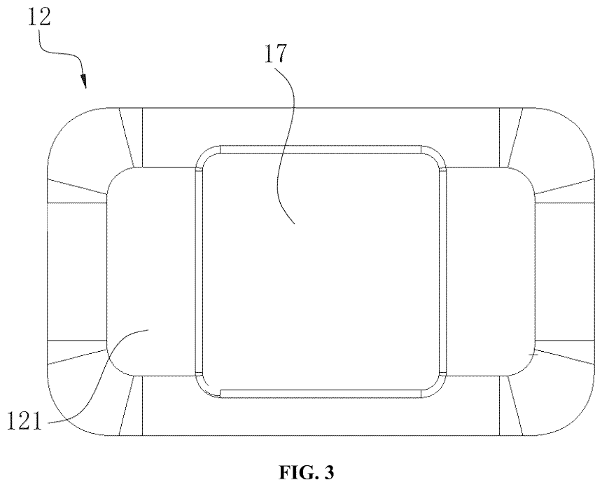

According to one embodiment of the present invention, as shown in FIG. 1, FIG. 3 and FIG. 7, the second wall 111 is provided with a second through hole 1111, and one end of the communication socket 13 penetrates through the second through hole 1111 to extend out of the accommodating cavity. As shown in FIG. 1, FIG. 2, FIG. 4 to FIG. 6, the outer wall surface of the second wall 111 is provided with a circle of protrusion 1114 corresponding to the second through hole 1111, a first cavity 1115 is arranged in the protrusion 1114, one end of the first cavity 1115 is communicated with the second through hole 1111, and the other end of the first cavity is communicated with the outside. A length of the protrusion 1114 is smaller than a length of the communication socket 13. The communication socket 13 sequentially penetrates through the second through hole 1111 and the first cavity 1115 to extend out of the accommodating cavity, and by arranging the protrusion 1114, the communication socket 13 can be better limited and protected in a circumferential direction, thus avoiding circumferential loosening and deviation of the communication socket 13.

According to one embodiment of the present invention, as shown in FIG. 2, cross-sectional shape and size of the first cavity 1115 are matched with cross-sectional shape and size of the second through hole 1111. In this way, the first cavity 1115 surrounded by the protrusion 1114 may better limit the communication socket 13. Certainly, the shape of the first cavity 1115 may be different from a shape of the communication socket 13, and the size of the first cavity 1115 is also different from a size of the communication socket 13. At this time, as long as the communication socket 13 can penetrate through the first cavity 1115, and then a filler is arranged between the inner wall of the first cavity 1115 and the outer wall of the communication socket 13 for bonding, the purpose of limiting the communication socket 13 can also be achieved.

According to one embodiment of the present invention, as shown in FIG. 1 and FIG. 4, the shell comprises a cover 11 and a lower shell 12; the cover 11 and the lower shell 12 both have a structure with one open end, and the open ends of the cover 11 and the lower shell 12 are detachably connected; and the accommodating cavity is formed between the open end of the cover 11 and the open end of the lower shell 12 which are connected. In this embodiment, the shell is composed of the cover 11 and the lower shell 12 which are detachable, which facilitates the maintenance and replacement of the memory 18, the fingerprint identification apparatus 17 and the like in the accommodating cavity. As shown in FIG. 4, the first wall 121 is a bottom wall of the lower shell 12, and the second wall 111 is a top wall of the cover 11.

As shown in FIG. 4 and FIG. 7, an inner wall of the open end of the lower shell 12 is provided with a circle of ring groove to form a sinking platform 1212, the open end of the cover 11 is inserted into the lower shell 12, and the open end of the lower shell 12 abuts against an outer wall surface of the sinking platform 1212. The sinking platform 1212 facilitates the assembly of the cover 11 and the lower shell 12, and limits an assembly position of the cover 11 and the lower shell 12. In this embodiment, the cover 11 and the lower shell 12 are made of a deformable elastic material (such as plastic), and the cover 11 and the lower shell 12 are fixed by interference fit. Certainly, in this embodiment, the cover 11 and the lower shell 12 may also be detachably connected by clamped connection or threaded connection.

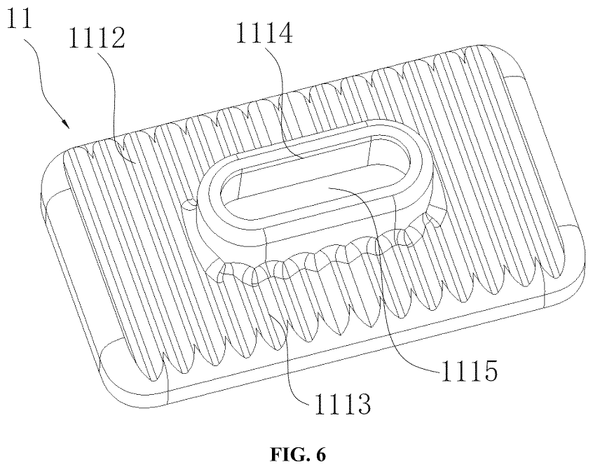

According to one embodiment of the present invention, as shown in FIG. 2, FIG. 4 and FIG. 6, the outer wall surface of the second wall 111 is provided with a plurality of parallel grooves 1112 arranged at intervals; and by arranging the grooves 1112, a convex strip 1113 is formed between two adjacent grooves 1112, which may buffer the contact between the mobile memory device 1 with fingerprint identification and the communication device. For example, in the case that the mobile memory device 1 with fingerprint identification is a U-drive and the communication device is a smart phone, when the communication socket 13 of the U-drive is inserted into the data interface of the mobile phone, the convex strips 1113 make contact with a shell of the mobile phone and deform under a stress to buffer a pressure, thus better protecting the mobile memory device 1 with fingerprint identification.

In the above embodiment of the present application, the communication interface may be a USB interface, a TepyC interface, a micro interface (Android interface) or a Lightning interface (iPhone interface), and the communication socket 13 has a structure adapted to a shape and a size of the communication interface.

In the description of the present invention, it should be noted that the orientation or position relationship indicated by the terms “up”, “down”, and the like is based on the orientation or position relationship shown in the drawings, it is only for the convenience of description of the present invention and simplification of the description, and it is not to indicate or imply that the indicated device or element must have a specific orientation, and be constructed and operated in a specific orientation. Therefore, the terms should not be understood as limiting the present invention. Moreover, the terms “first” and “second” are used for descriptive purposes only and cannot be understood as indicating or implying relative importance.

In the description of the present invention, it should be noted that the terms “installation”, “communication” and “connection” should be understood in a broad sense unless otherwise specified and defined. For example, they may be fixed connection, removable connection or integrated connection; may be mechanical connection or electrical connection; and may be direct communication, or indirect communication through an intermediate medium, and communication inside two elements. The specific meanings of the above terms in the present invention may be understood in a specific case by those of ordinary skills in the art. In addition, in the description of the present invention, unless otherwise specified, the term “multiple” refers to being two or more.

Those described above are merely preferred embodiments of the present invention, but are not intended to limit the present invention. Any modifications, equivalent substitutions and improvements made in the spirit and principle of the present invention should all fall within the scope of protection of the present invention.

We claim:

1. A mobile memory device with fingerprint identification, comprising a shell, a fingerprint identification apparatus (17) and a communication socket (13);
wherein, an accommodating cavity is formed in the shell, one end of the communication socket (13) is located in the accommodating cavity, and the other end of the communication socket extends out of the accommodating cavity; and one surface of the fingerprint identification apparatus (17) used for acquiring a fingerprint is located on an outer side of the shell, and a direction of a pressing force applied on the fingerprint identification apparatus when the fingerprint identification apparatus acquires the external fingerprint is parallel to a length direction of the communication socket (13).

2. The mobile memory device with fingerprint identification according to claim 1, wherein the shell is provided with a first wall (121) and a second wall (111) which are oppositely arranged; and
the fingerprint identification apparatus (17) is mounted on the first wall (121), one end of the communication socket (13) is located in the accommodating cavity, and the other end of the communication socket penetrates through the second wall (111) to extend out of the accommodating cavity; and the length direction of the communication socket (13) is perpendicular to a plane on which the fingerprint identification apparatus (17) is located.

3. The mobile memory device with fingerprint identification according to claim 2, wherein the first wall (121) is parallel to the second wall (111), the length direction of the communication socket (13) is perpendicular to a plane on which the second wall (111) is located, and the plane on which the fingerprint identification apparatus (17) is located is parallel to a plane on which the first wall (121) is located.

4. The mobile memory device with fingerprint identification according to claim 3, wherein the first wall (121) of the shell is provided with a first through hole (1211) communicated with the accommodating cavity, and the fingerprint identification apparatus (17) is located in the first through hole (1211).

5. The mobile memory device with fingerprint identification according to claim 4, wherein the second wall (111) is provided with a second through hole (1111) communicated with the accommodating cavity, and one end of the communication socket (13) penetrates through the second through hole (1111) to extend out of the accommodating cavity.

6. The mobile memory device with fingerprint identification according to claim 5, wherein an outer wall surface of the second wall (111) is provided with a circle of protrusion (1114) corresponding to the second through hole (1111), a first cavity (1115) is arranged in the protrusion (1114), one end of the first cavity (1115) is communicated with the second through hole (1111), and the other end of the first cavity is communicated with the outside.

7. The mobile memory device with fingerprint identification according to claim 6, wherein cross-sectional shape and size of the first cavity (1115) are matched with cross-sectional shape and size of the second through hole (1111).

8. The mobile memory device with fingerprint identification according to claim 5, wherein the shell comprises a cover (11) and a lower shell (12); and
the cover (11) and the lower shell (12) both have a structure with one open end, and the open ends of the cover (11) and the lower shell (12) are detachably connected; and the accommodating cavity is formed between the cover (11) and the lower shell (12).

9. The mobile memory device with fingerprint identification according to claim 8, wherein an inner wall of the open end of the lower shell (12) is provided with a circle of ring groove to form a sinking platform (1212), the open end of the cover (11) is inserted into the lower shell (12), and the open end of the lower shell (12) abuts against an outer wall surface of the sinking platform (1212).

10. The mobile memory device with fingerprint identification according to claim 2, wherein an outer wall surface of the second wall (111) is provided with a plurality of parallel grooves (1112) arranged at intervals.
